(19) United States
(12) Patent Application Publication
(10) Pub. No.: US 2023/0264376 A1
(43) Pub. Date: Aug. 24, 2023

(54) PORTIONING BELT UNIT, SLICING MACHINE EQUIPPED THEREWITH, METHOD FOR RETOOLING SUCH A SLICING MACHINE

(71) Applicant: MULTIVAC SEPP HAGGENMUELLER SE & CO. KG, Wolfertschwenden (DE)

(72) Inventors: Andre MORENO, Breidenbach (DE); Christoph MEHL, Kirchzell (DE); Nikolai WEBER, Biedenkopf (DE)

(73) Assignee: MULTIVAC SEPP HAGGENMUELLER SE & CO. KG, Wolfertschwenden (DE)

(21) Appl. No.: 18/105,420

(22) Filed: Feb. 3, 2023

(30) Foreign Application Priority Data
Feb. 3, 2022 (DE) 102022102512.8

(51) Int. Cl. B26D 7/06

(52) U.S. Cl. CPC B26D 7/0625; B26D 7/0683; B26D 2210/02

(57) ABSTRACT

In order that in a portioning belt unit with only two deflecting drums, the rear one of which serves as a drive drum and requires a large wrap angle, the rear end of the upper run of the portioning belt does not become increasingly more declined towards the rear until it reaches the vertical, in accordance with the curvature of the upper side of this drive drum, a smaller rearmost deflecting drum is provided, and the upper run is held bent between the foremost and rearmost deflecting drums with an approximately horizontal front section and an obliquely rearwardly sloping rear section by correspondingly supporting the upper run by a belt support plate or a center deflecting drum.

### CROSS-REFERENCE TO RELATED APPLICATIONS

This application claims priority to German Patent Application No. DE 102022102512.8 filed on Feb. 3, 2022, the disclosure of which is incorporated in its entirety by reference herein.

### TECHNICAL FIELD

The invention relates to slicing machines, in particular so-called slicers, which are used in the food industry to slice strands of an only slightly compressible product such as sausage or cheese.

### BACKGROUND

Since these strands can be produced with a cross section that retains its shape and dimensions well over its length, i.e., essentially constant, they are called product calibers.

In most cases, several product calibers arranged parallel to each other are cut open at the same time by cutting off one slice at a time from the same blade, which moves in a transverse direction to the longitudinal direction of the product calibers.

The product calibers are pushed forward by a feed conveyor of a cutting unit in the direction of the blade of the cutting unit, usually on an obliquely downwardly directed feed conveyor, and are each guided through the product openings of a plate-shaped, so-called cutting frame, at the front end of which the part of the product caliber projecting beyond it is cut off as a slice by the blade immediately in front of the cutting frame.

The slices generally fall onto a discharge conveyor of a discharge unit, by means of which they are transported away for further processing.

The first discharge conveyor of the discharge unit in the transport direction is generally designed as a portioning belt for accumulating several slices in shingled or stacked portions, in that its conveyor belt can be driven in a controlled stepwise manner in, preferably both, directions of rotation.

The inclination of the upper run of the portioning belt can be adjusted in that a pivot unit of the portioning belt unit, in which its deflection drums are mounted, can be pivoted about a pivot axis extending in the transverse direction and arranged at the downstream end, usually the rotation axis of the downstream environmental deflection drum.

There is the problem that, especially in the case of very flat product calibers, i.e., inserted into the slicing machine and viewed from the side, for example with a height, i.e., thickness, of less than 5 cm, and correspondingly very short slices in the transport direction, the rear end of these slices already hits the upstream deflection drum in the wrap-around area of the upper run after they have been cut off from the caliber and thus has a very strong inclination, so that downward slipping can occur.

This has an increased effect in the case of shingled portions, where the next impinging slices rest with their front area on the already formed part portion and lie at an even greater inclination.

To remedy this situation, the entire portioning belt unit was previously adjusted downwards and shifted in the direction of the blade. In order to prevent a collision with the blade, a shorter lifting connecting rod for the portioning belt unit usually had to be installed to limit the lifting height.

This caused long machine downtimes for the changeover procedure.

### SUMMARY

It is therefore the object of the invention to provide a portioning belt unit and, in particular, a slicing machine, especially a slicer, equipped therewith, which avoids these disadvantages, as well as a corresponding changeover process.

A generic portioning belt unit comprises a base body in which a pivot unit is pivotably mounted about a pivot axis extending in the transverse direction. This pivot unit comprises an endless conveyor belt circulating over deflecting drums, which in this portioning belt unit is called a portioning belt, which circulates over at least two deflecting drums, i.e., a foremost first deflecting drum and a rearmost last deflecting drum in the transport direction, of which one is designed as a drive drum in that it is operatively connected to a drive shaft which can be driven in a controlled manner.

The drive shaft is driven externally, i.e., in the case of a portioning belt unit used in a slicing machine, it is driven in rotation by a drive socket on the machine side.

With regard to the base body, it should be clarified that this is a component of the portioning belt unit, but in the case of a slicing machine with a removable portioning belt unit, it does not necessarily have to be a component of the removable part of the portioning belt unit, but can be a machine-fixed part, for example merely a counterholder for the pivot unit, with which it comes into operative connection after the remaining portioning belt unit has been inserted into the slicing machine.

In most cases, however, the base body will be part of the part of the portioning belt unit that can be removed from the machine, and in the following the description will be directed only to this embodiment.

According to the invention, the existing task is solved by the fact that—viewed in transverse direction—the upper run of the portioning belt has two sections standing at an angle to each other, namely a front upper run section in transport direction, which runs approximately horizontally, in particular in the installed state, and a rear upper run section which rises from the rear end up to the height of the front upper run section.

The intermediate angle between the two sections measured at the bottom of the upper run is between 90° and 180°, preferably between 115° and 145°.

The rearmost deflecting drum has the smallest effective diameter in the sense that the other deflecting drums have at least the same effective diameter.

Preferably, at least the first deflecting drum, in particular all deflecting drums, has a larger effective diameter than the last deflecting drum.

As a result, the inclination of the upper run of the portioning belt rotating around the deflecting drums, in particular in the impact area for the separated slices, i.e., the rear upper run section, can be adjusted as desired and in particular in such a way that no slipping down of slices or partial slices can occur against the transport direction.

The pivot axis of the pivot unit is preferably located in the transport direction between the rotation axis of the first and the last deflecting drum, preferably the rotation axis of the first deflecting drum and/or the drive shaft serves as the pivot axis. In the latter case, the drive shaft then remains stationary, which facilitates driving of the drive shaft, since a drive socket on the machine side can then also remain stationary.

To bring about the angled upper run, the upper run is supported at least between the rear and front upper run sections either by a deflecting drum resting against the upper run from below, which in turn runs in the transverse direction, or by a belt support plate, which can also extend below the rear and/or front upper run sections.

This means that different designs of the pivot unit are available.

In its axial direction, the drive shaft has, on the one hand, an input end at which it is driven by a machine-side drive socket, for example, and, on the other hand, an output end at which the active connection to the deflecting drum actively connected thereto is arranged.

The input end is usually located on the side facing away from the operator, on which the portioning belt unit is usually cantilevered on one side when mounted.

If the drive shaft extends in transverse direction over the entire width of the portioning belt, the output end is usually located on the side opposite the longitudinal center of the portioning belt, preferably the operator side.

However, the output end of the drive shaft can also be located on the same side of the portioning unit, preferably facing away from the operator side, so that the drive shaft is then very short in the axial direction only, in which case the active connection with respect to the driven deflecting drum can also be located on this side of the longitudinal center plane of the portioning belt unit—more precisely the longitudinal center plane which is perpendicular and extends in the transport direction—as the drive end.

The operative connection at the output end generally consists of a pinion over which, for example, a toothed belt or a chain runs, which also rotates over a further pinion that is non-rotatably present on the driven deflecting drum, resulting in a very simply designed drive.

Preferably, the drive shaft—viewed in the axial direction of the drive shaft—is arranged between the upper run and the lower run of the conveyor belt, resulting in a particularly compact design of the portioning belt unit. This also makes it possible to design the drive shaft, which extends over the entire width, as a driven deflecting drum over which at least the upper run of the portioning belt circulates.

To avoid excessive inclination between the rearmost deflecting drum and the drive shaft designed as a driven middle deflecting drum, i.e., arranged between the first and last deflecting drum, the wrap angle of the drive shaft through the conveyor belt is a maximum of 35°, in particular only a maximum of 30°.

In particular, the foremost or rearmost deflecting drum is also driven either directly by the drive shaft or by the deflecting drum driven by it, in particular the central deflecting drum.

Preferably, the portioning belt unit is designed in such a way that it can be disassembled from a slicing machine or installed in such a slicing machine very quickly, preferably within 30 seconds, and/or without special tools, in particular completely without tools.

By special tool is meant any tool which goes beyond usual screwdrivers or attachable screw nuts for moving polygonal screw heads or commercially available grippers.

With regard to the slicing machine, in particular a slicer, which is used for slicing product calibers, such as foodstuffs like sausage or cheese, and creating portions from the slices, it comprises the usual modules like
a cutting unit with a rotating blade,
a feed unit for feeding the at least one caliber to the cutting unit,
a discharge unit for discharging the created slices or portions, comprising the at least one portioning belt unit,
a drive socket which can be driven in a controlled manner for coupling with the drive shaft of the portioning belt unit,
a control for controlling moving parts of the slicing machine,
   wherein according to the invention the portioning belt unit is embodied as described above.

Viewed in the transverse direction, the upper run section at the rear in the transport direction runs approximately parallel to the cutting plane or can at least be set to this position. Approximately parallel means with a deviation therefrom of at most +/−10°, preferably at most +/−5°.

In particular, in addition to the portioning belt unit, the rest of the slicing machine, in particular the rest of the discharge unit, is also embodied in such a way that the portioning belt unit can be quickly removed from or installed in the rest of the slicing machine, in particular without special tools, preferably completely without tools.

In this context, the previously established definitions apply with regard to the terms “quickly” and “special tool”.

Preferably, a locking device is provided which, after insertion of the portioning belt unit in transverse direction into the slicing machine, locks the portioning belt unit in this inserted operating position and prevents unintentional release and extraction in transverse direction.

The locking device comprises at least one locking element on the portioning belt unit side and at least one counter element on the rest of the cutting machine side, of which either the locking element or the counter element is movable so that the two can be brought into and out of operative connection.

With regard to the method for changing over a slicing machine, in particular for slicing very flat product calibers or for reverse shingling, especially in the case of a slicing machine as described above, the changeover is generally effected by changing the portioning belt unit on the slicing machine, in particular by changing it as a whole.

According to the invention, this change is carried out by pulling the old portioning belt unit located in the slicing machine out of the machine in the transverse direction towards the operator side only after releasing a locking device, and thereby pulling it off a drive socket on the machine side, and then inserting the new portioning belt unit in the transverse direction only from the operator side, and thereby connecting it operatively to the drive socket.

After locking the locking device, the new portioning belt unit—which has been optimized for the particular job—and thus the entire slicing machine is ready for operation.

Even before, but preferably only after, the new portioning belt unit is inserted into the machine, the pivot unit of the portioning belt unit is pivoted relative to its base body in such a way that, during the planned work operation, a portion or partial portion no longer slides down against the transport direction from the upper run, in particular the start of the upper run of the portioning belt of the portioning belt unit.

A very flat product caliber is preferably understood to mean product calibers whose height when viewed from the side in the slicing machine is less than 5 cm.

Reverse shingling is understood to mean a type of slice that is shingled in the transport direction, i.e., partially overlapping in the transport direction, in which the portioning belt of the portioning belt unit must move stepwise in the opposite direction to the transport direction, since the visible overlap of the slices with respect to one another is located at the rear end of the respective slice, which is located in the opposite direction to the transport direction.

### BRIEF DESCRIPTION OF THE DRAWINGS

Embodiments according to the invention are described in more detail below as examples, with reference to the drawings which show:

FIGS. 1a, b: a slicing machine in the form of a slicer according to the prior art in different perspective views, with the feed belt tilted up into the slicing position,

FIG. 2a: a simplified side view of the slicing machine, free of housing parts, so that the individual conveyor belts can be seen more clearly, loaded with a product caliber,

FIG. 2b: a side view as in FIG. 2a, but with the infeed belt tilted down into the loading position and the product caliber cut except for a caliber rest,

FIGS. 3a, b: a detailed side view of the portioning belt unit in two different operating positions, enlarged compared to FIGS. 2a, b,

FIG. 4a: a schematic sketch of a known embodiment of a portioning belt unit,

FIGS. 4b-d: a schematic sketch of the portioning belt unit according to the invention, and

FIGS. 5a, b: a perspective view of the portioning belt unit in two separate embodiments according to the invention.

### DETAILED DESCRIPTION

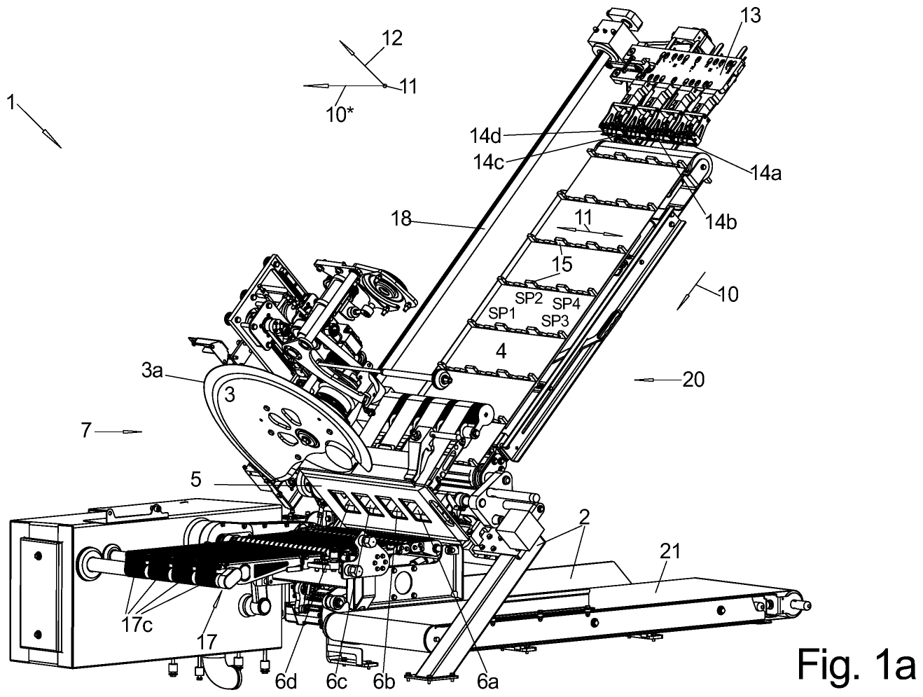

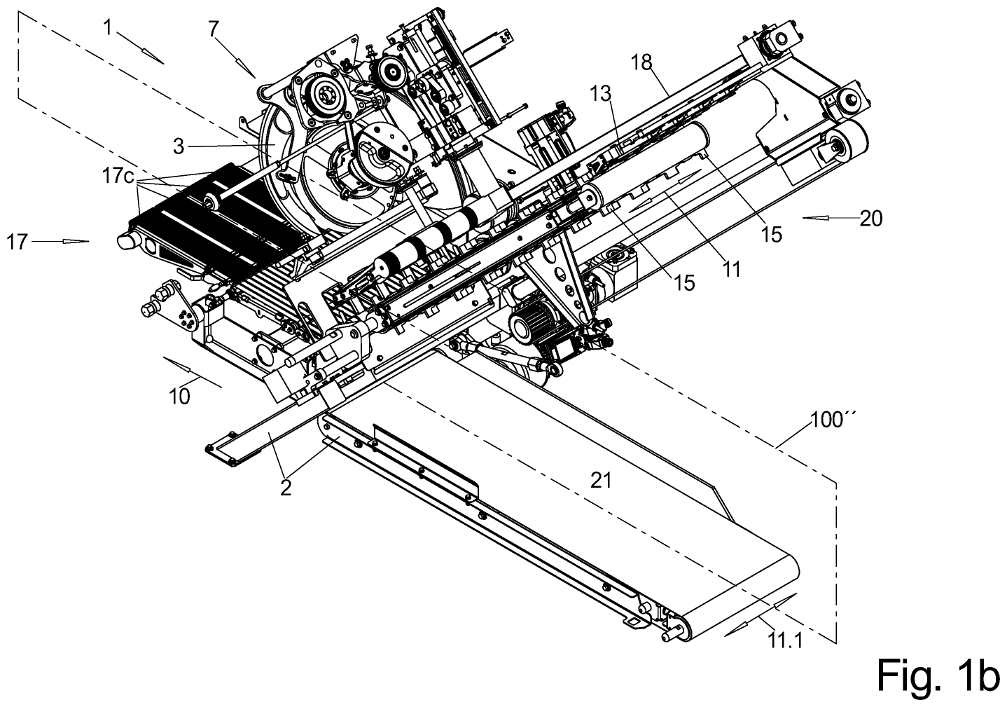

FIGS. 1a, 1b show different perspective views of a multi-track slicer 1 for simultaneous slicing of several product calibers K on one track SP1 to SP4 next to each other and depositing in shingled portions P each consisting of several slices S with a general passage direction 10* through the slicer 1 from right to left.

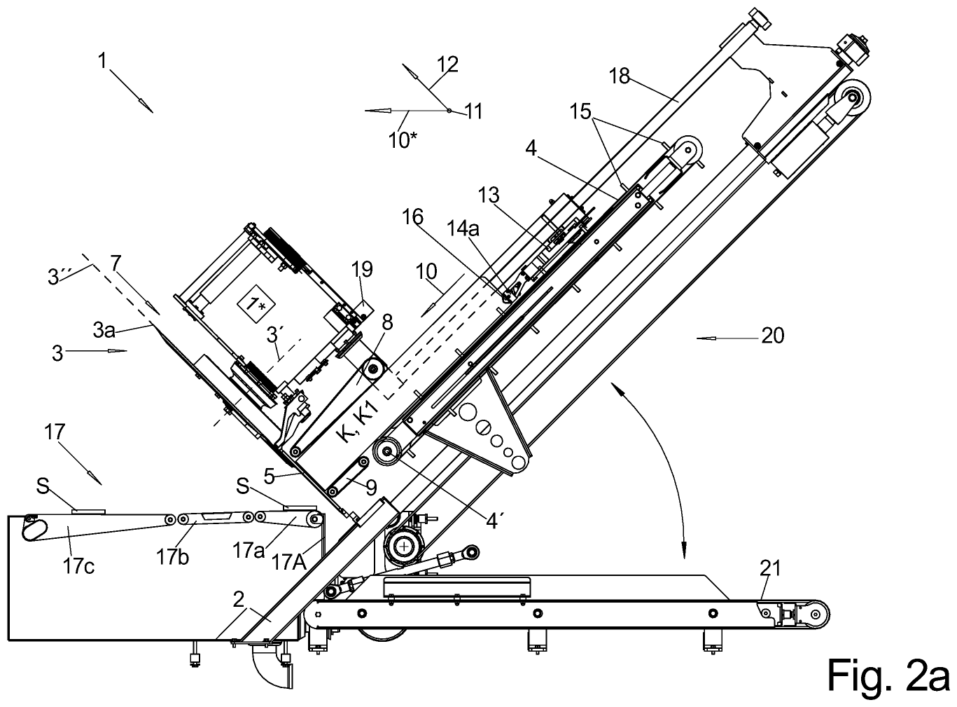

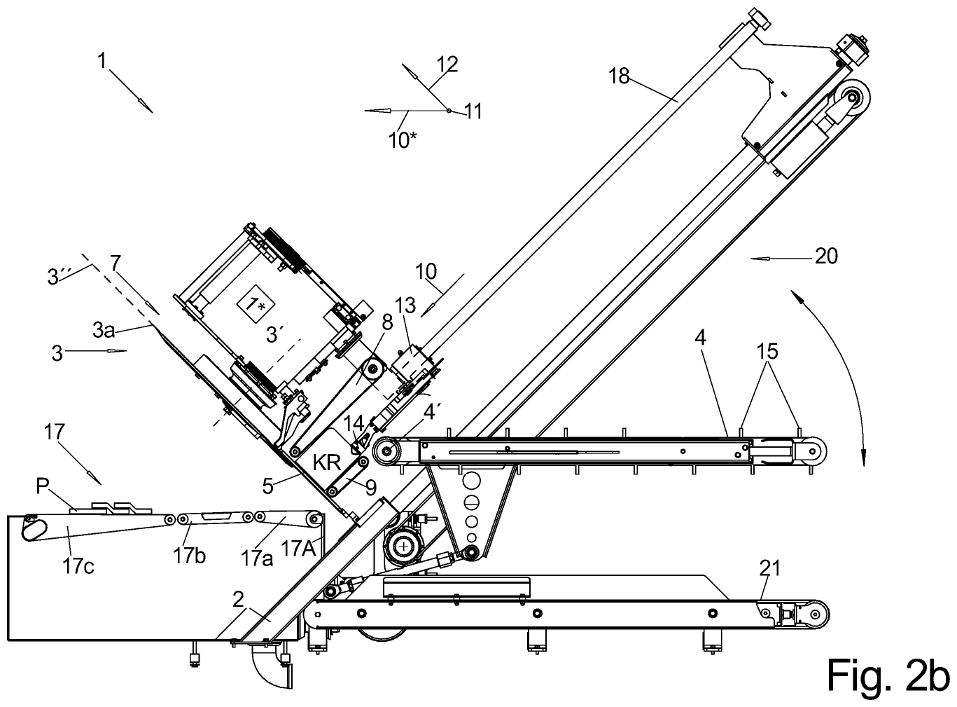

FIG. 2a shows—with the caliber K inserted—a side view of this slicer 1, omitting covers and other parts not relevant to the invention, which are attached to the base frame 2 in the same way as all other units, so that the functional parts, especially the conveyor belts, can be seen more clearly. The longitudinal direction is the feeding direction of the calibers K to the cutting unit 7, and thus also the longitudinal direction of the calibers K lying in the slicer 1.

It can be seen that the basic structure of a slicer 1 according to the state of the art is that to a cutting unit 7 with a blade 3 rotating about a blade axis 3′, such as a sickle blade 3, several, in this case four, product calibers K lying transversely to the feeding direction 10 next to one another on a feed conveyor 4 with spacers of the feed conveyor 4 between them are fed by this feed unit 20, from each of whose front ends the rotating blade 3 cuts off a slice S with its cutting edge 3a in one operation, i.e., almost simultaneously.

For slicing the product calibers K, the feed conveyor 4 is in the slicing position shown in FIGS. 1a-2a, which is inclined in side view with a low-lying cutting-side front end and a high-lying rear end, from which it can be folded down about a pivot axis 20′ running in its width direction, the first transverse direction 11, which is located in the vicinity of the cutting unit 7, into an approximately horizontal loading position as shown in FIG. 2b.

The rear end of each caliber K lying in the feed unit 20 is held positively by a gripper 14a-d with the aid of gripper claws 16 as shown in FIG. 2a. These grippers 14a-14d, which can be activated and deactivated with respect to the position of the gripper claws 16, are attached to a common gripper slide 13, which can be moved along a gripper guide 18 in the feeding direction 10.

Both the advance of the gripper slide 13 and of the feed conveyor 4 can be driven in a controlled manner, but the actual feed speed of the calibers K is effected by a so-called upper and lower product guide 8, 9, which are also driven in a controlled manner and which engage on the upper side and lower side of the calibers K to be cut open in their front end regions near the cutting unit 7:

The front ends of the calibers K are each guided through a so-called eyeglass opening 6a-d of a plate-shaped cutting frame 5, the cutting plane 3″ running directly in front of the front, inclined downward-pointing end face of the cutting frame 5, in which cutting plane the blade 3 rotates with its cutting edge 3a and thus cuts off the protrusion of the calibers K from the cutting frame 5 as a slice S. The cutting plane 3″ runs perpendicular to the upper run of the feed conveyor 4 and/or is spanned by the two transverse directions 11, 12 to the feeding direction 10.

In this case, the inner circumference of the product openings 6a-d of the cutting edge 3a of the blade 3 serves as a counter cutting edge.

Since both product guides 8, 9 can be driven in a controlled manner, in particular independently of each other and/or possibly separately for each track SP1 to SP4, these determine the—continuous or clocked—feed speed of the calibers K through the cutting frame 5.

The upper product guide 8 is displaceable in the second transverse direction 12—which is perpendicular to the surface of the upper run of the infeed conveyor 4—for adaptation to the height H of the caliber K in this direction. Furthermore, at least one of the product guides 8, 9 can be designed to be pivotable about one of its deflecting rollers in order to be able to change the direction of the strand of its guide belt resting against the caliber K to a limited extent.

The slices S standing obliquely in space during separation fall onto a discharge conveyor 17 which begins below the cutting frame 5 and runs in the passage direction 10* and which in this case consists of a plurality of discharge units 17a, b, c arranged one behind the other in the passage direction 10* with the upper runs of their conveyor belts approximately in alignment, of which the first discharge unit 17a in the passage direction 10 can be embodied as a portioning belt unit 17a and/or can also be embodied as a weighing unit.

The slices S can strike the portioning belt unit 17a individually and at a distance from each other in the passage direction 10* or form shingled or stacked portions P by appropriate control of the portioning belt 17a of the discharge conveyor 17—the movement of which, like almost all moving parts, is controlled by the control 1*—by stepwise forward or backward movement of the portioning belt 22.

Below the feed conveyor unit 20 there is usually an approximately horizontal residue conveyor 21, which starts with its front end below the cutting frame 5 and directly below or behind the discharge conveyor unit 17 and with its upper run thereon—by means of the drive of one of the discharge conveyors 17 against the passage direction 10—transports falling rest pieces to the rear.

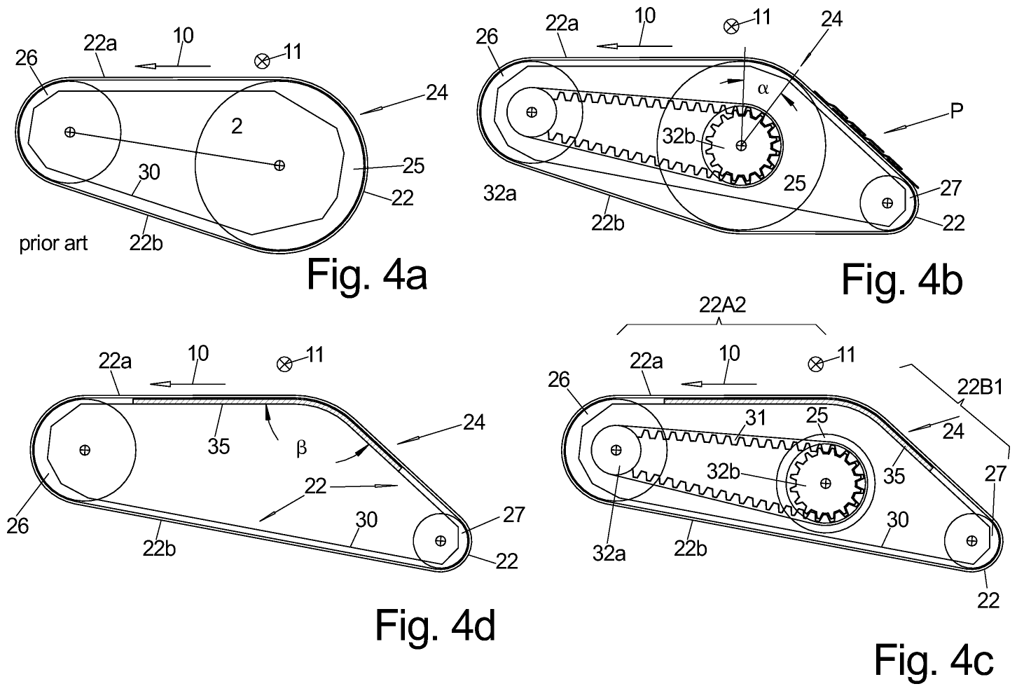

FIG. 4a shows in principle a previously frequently used design of a portioning belt unit 17a, in which the portioning belt 22 circulates over only two deflecting drums, namely a front deflecting drum 26 in transport direction 10 and a rear deflecting drum 25, which is driven as a drive shaft 25 and serves as a drive drum and has a larger diameter than the front deflecting drum 26.

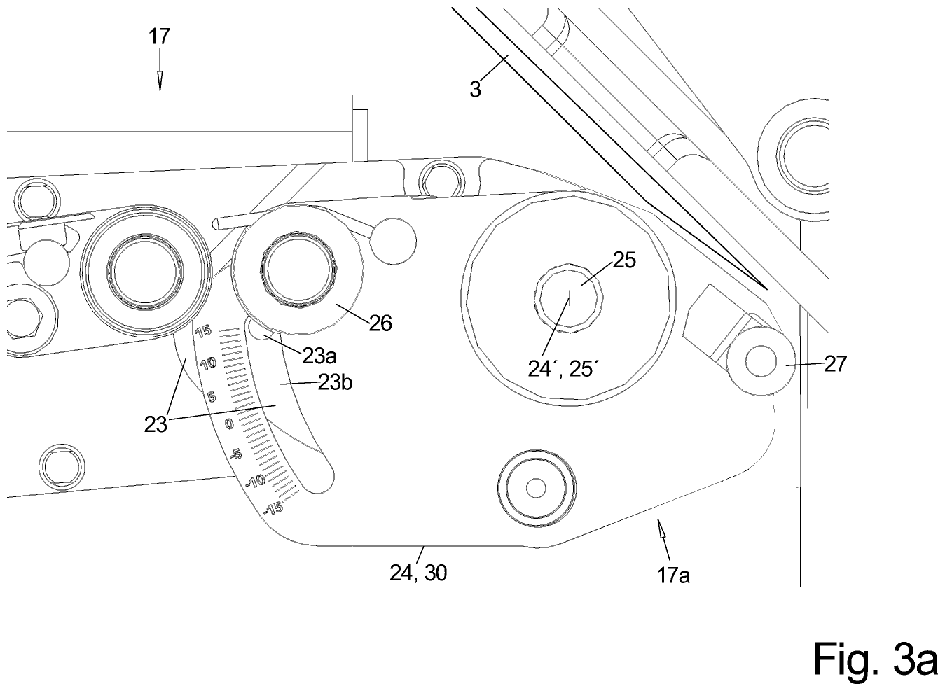

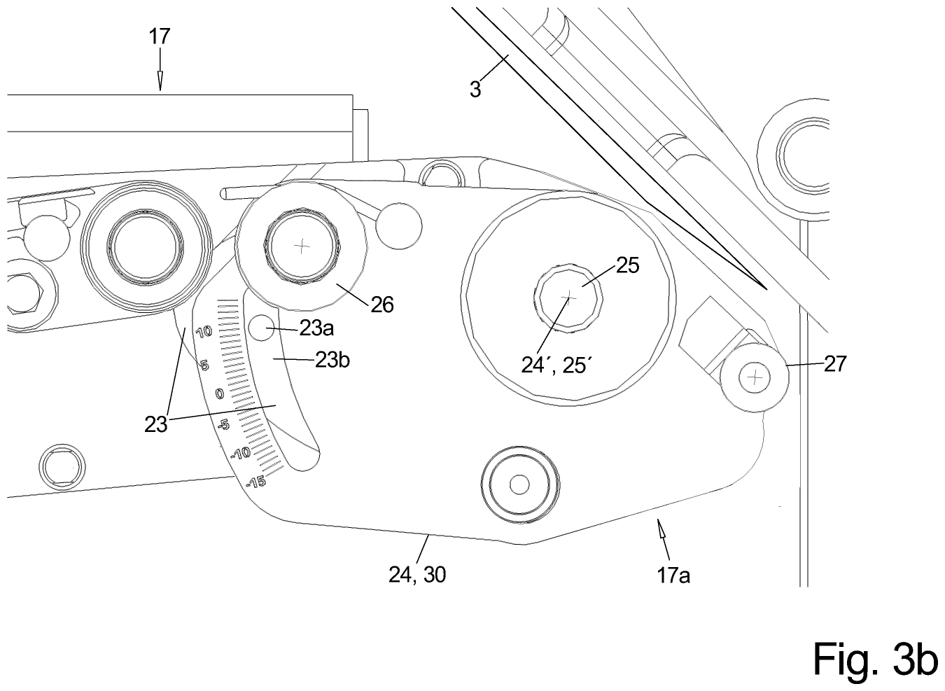

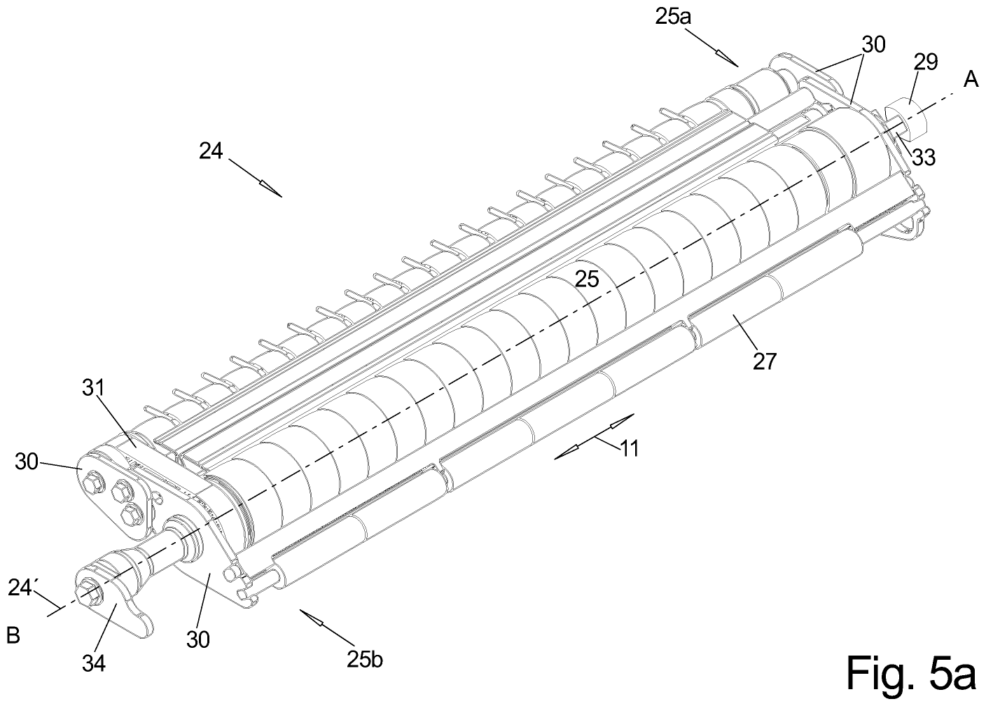

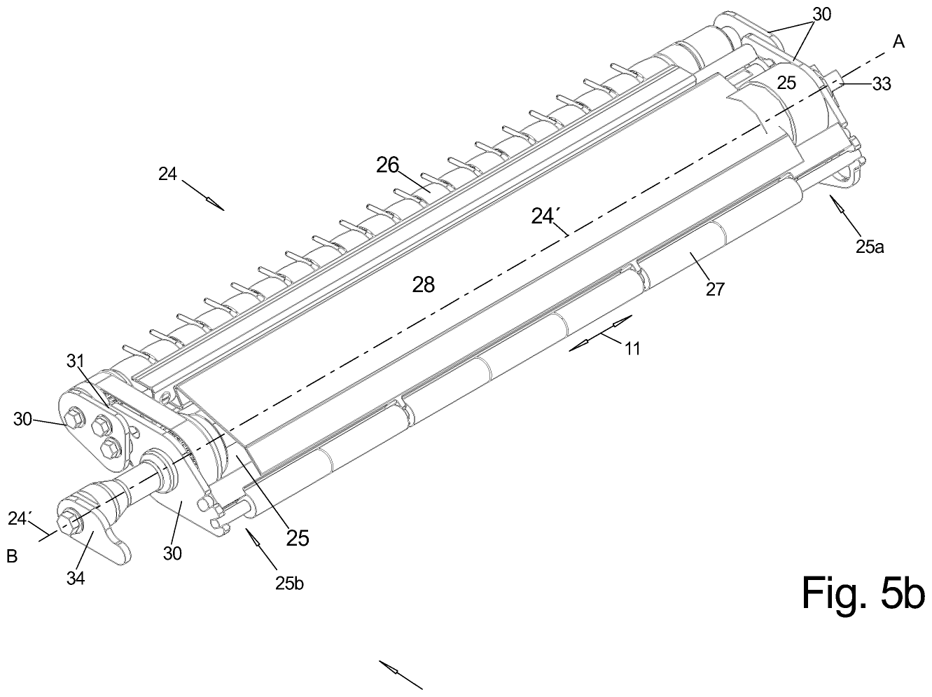

Specifically, only the pivot unit 24 of the portioning belt unit 17a is shown in FIG. 4a—and also in FIGS. 4b, c and d—with, as seen in the direction of view, two side cheeks 30, one behind the other, in which the deflecting drums are mounted—as can be seen better in FIG. 5a, b—whereby the entire pivot unit 24 is mounted in a base body 23, which is not shown—which is only shown in FIGS. 2a, b and in FIGS. 3a, b—can be pivoted about a pivot axis running in the transverse direction 11, in FIG. 4a the rotation axis of the front deflecting drum 26, and can also be moved vertically as a whole on a base frame 17A of the discharge conveyor 17.

In order to avoid the rapidly increasing slope of the upper run of the portioning belt 22 in the direction opposite to the transport direction 10 from the rotation axis of the rear deflecting drum 25 to the rear, the portioning belt 22 is also guided around a foremost and a rearmost deflecting drum 26, 27, but the upper run 22a is kept curved convexly outwardly between them by an additional guide element, so that only a rear upper run section 22A1 of the upper run 22a runs at an incline and a front upper run section 22A2 of the upper run 22a runs approximately horizontally.

In the embodiment according to FIG. 4b, the guide element is a further deflecting drum 25 which is arranged in the region between the foremost and rearmost deflecting drums 26, 27, is driven as a drive shaft 25 and serves as a drive roller and, in particular, has a larger diameter than the other two deflecting drums 26, 27.

Due to the presence of the rearmost deflecting drum 27, the wrap angle α with which the portioning belt 22 wraps around this driven deflecting drum is much smaller than in the prior art according to FIG. 4a, even if—as shown in FIG. 4b—this drive roller 25 is in engagement with both the upper run 22a and the lower run 22b and the wrap angle α is the sum of the two wrap angles α1 and α2.

However, this is not sufficient to reliably prevent slippage between them. For this reason, one of the two foremost or rearmost deflecting drums 26, 27 is also embodied as a drive roller, in this case the foremost deflecting drum 26, where the wrap angle is sufficient, namely at least 50°, better at least 60°, better at least 70°.

This can also be the identical deflection roller 25 as in the previous embodiment according to FIG. 4a, which facilitates the creation of portioning belt units from a modular system that contains the various individual deflection rollers and different types of side cheeks as well as base bodies as modular elements.

The deflecting drum 26 is driven by the drive roller 25 via a toothed belt 31 and in each case a pinion 32a, 32b arranged in a rotationally fixed manner, usually on the front side, on both the deflecting drum 26 and the deflecting drum 25.

The drive of the entire portioning belt unit 17a is preferably brought from the machine 1 at the position of the deflecting drum 25 via a drive socket which is stationary in the machine.

In order to be able to exchange the portioning belt unit 17a according to the invention also subsequently for a portioning belt unit according to the state of the art, for example according to FIG. 4a, the drive journal 33 of the portioning belt unit 17a must be located at the analogous position, for example again coaxially to the previous drive roller 25.

In addition, FIG. 4b shows in the upper run section 22A1 a backward shingled portion P consisting of several slices S partially overlapping each other in transport direction 10, which is just produced with a portioning belt 22 running against the usual transport direction 10, which is why the front area of a slice S is overlapped by the rear area of a slice S following in transport direction 10. Due to the backward running, the falling of a slice is particularly easy due to the kinetic energy which the slices S receive during the backward running.

FIG. 4c shows a design according to the invention in which the drive shaft 25 is present between the foremost and rearmost deflecting drums 26, 27, but is no longer in contact at least with the upper run 22a of the portioning belt 22, and in particular also not with the lower run 22b.

The drive shaft 25 thus only serves to supply the driving force in the form of a rotation of the drive shaft 25, primarily from the anti-operator side A to the operator side B, as shown in FIG. 5a, of the portioning belt unit 17a, and to drive a pinion 32b, which is attached to it in a rotationally fixed manner and which, via the toothed belt 31, in turn drives the one, preferably foremost, deflecting drum 26 via a drive pinion 32a located there.

FIG. 4d shows a further design according to the invention, which differs from those of FIGS. 4b, c in that there is no drive shaft 25 at all, a fortiori not designed as a drive drum which is in contact with the portioning belt 22, but in particular only the foremost and the rearmost deflecting drum 26, 27 are present as a single deflecting drum, with the belt support plate 35 between them, which supports the upper run 22a.

Then one of these two deflecting drums, for reasons of space preferably the downstream, front deflecting drum 26, can be driven in a controlled manner, for which purpose a drive socket 29 is preferably provided coaxially thereto in the machine 1.

Pivot units 24 according to the principles of FIGS. 4b, c are shown in FIGS. 5a, b in a realistic, perspective view.

There, additionally, on the anti-operator side A facing away from the operator side B, the drive journal 33 projecting from the rotation axis of the drive shaft 25 on the end face, connected to it in a rotationally fixed manner and providing a positive fit, can be seen, which, in the assembled state, is in operative connection with a drive socket 29 on the machine side, as well as a pivoted lever which can be pivoted about this axis and is arranged on the operator side B and which is part of the locking device 34 by means of which the portioning belt unit 17a inserted into the slicer 1 is locked in the machine.

FIGS. 3a, b show in the side view according to FIG. 2a, b a portioning belt unit 17a according to the invention mounted in the machine 1 according to the basic principle of FIG. 4b in two different functional positions.

In addition to the pivot unit 24 with the side cheeks 30, in which the three deflecting drums 25, 26, 27 are mounted, a part of the base body 23 can also be seen there, which is installed in a fixed position in the machine 1, in particular the discharge conveyor 17, and with respect to which the pivot unit 24 can be pivoted, in this case about a pivot axis 24′ which is identical to the rotation axis 25′ of the drive shaft 25.

For a reproducible pivot position of the pivot unit 24, the latter has an oblong hole 23b in the form of an arc of a circle with respect to the pivot axis 24′ in the operator-side side cheek 30, through which a fixed indicator pin 23a of the base body 23 is visible or projects into or through the oblong hole. Along this oblong hole 23b, a degree scale is applied for setting a defined rotational position of the pivot unit 24.

In FIG. 3b, the pivot unit 24 is pivoted a few degrees clockwise about the pivot axis 24′ compared to FIG. 3a, whereby more distance can be achieved between the blade 3 and the rear beginning of the upper run 22a of the portioning belt 22, accompanied by a greater inclination of the rear beginning of the upper run 22a.

### REFERENCE LIST

1 slicing machine, slicer
1″ longitudinal center plane
1* control
2 base frame
3 blades
3 rotation axis
3″ blade plane, cutting plane
3a cutting edge
4 feed conveyor, feed belt
5 cutting frame
6a-d product opening
7 cutting unit
8 upper product guide, upper guide belt
8.1 contact run, lower run
8a cutting side deflecting roller
8b deflecting roller facing away from the cutting side
9 bottom product guide, lower guide belt
8.1 contact run, upper run
9a cutting side deflecting roller
9b deflecting roller facing away from the cutting side
10 transport direction, longitudinal direction, axial direction
10* passage direction through machine
11 1. transverse direction (width slicer)
12 2nd transverse direction (height-direction caliber)
13 gripper unit, gripper slide
14,14 a-d gripper
15 spacer
15′ support surface
16 gripper claw
17 discharge conveyor device
17A base frame
17a portioning belt unit
17a, b, c discharge conveyor unit
18 gripper guide
19 height sensor
20 feed unit
21 end piece conveyor
22 conveyor belt, portioning belt
22A upper run
22B lower run
23 base body
23a indicator pin
23b oblong hole
24 pivot unit
24′ pivot axis
25 drive shaft
25a input end
25 b output end
26 foremost deflecting drum
27 rearmost deflecting drum
28 deflecting drum
29 drive socket
30 side cheek
31 toothed belt
32a, b pinion
33 drive journal
34 locking device
35 belt support plate
α wrap angle
β intermediate angle
A anti-operator side
B operator side
K product, product caliber
KR end piece
S slice
P portion

1. A portioning belt unit with
a base body,
a pivot unit pivotable relative to the base body about a pivot axis extending in the transverse direction, comprising:
at least one endless conveyor belt, the portioning belt, circulating over deflecting drums,
a foremost, first deflecting drum in the transport direction of the portioning belt unit,
a rearmost, last deflecting drum parallel to the first deflecting drum in the transport direction,
a drive shaft, which can be driven in a controlled manner, for driving the portioning belt, which is operatively connected to one of the deflecting drums of the portioning belt,
wherein
viewed in the axial direction of the deflecting drums, the first transverse direction, the upper run of the portioning belt runs at an angle with a rear upper run section and a front upper run section and an intermediate angle therebetween measured at the underside of the upper run of between 90° and 180°, in particular between 115° and 145°,
at least one of the deflecting drums has an effective diameter equal to or greater than that of the last deflecting drum.

2. The portioning belt unit according to claim 1, wherein
the first deflecting drum has a larger effective diameter than the last deflecting drum,
in particular all other deflecting drums have a larger effective diameter than the last deflecting drum.

3. The portioning belt unit according to claim 1,
wherein
the pivot axis is arranged in the transport direction between the rotation axes of the first and the last deflecting drum,
in particular the pivot axis is the rotation axis of the drive shaft and/or of the first deflecting drum.

4. The portioning belt unit according to claim 1,
wherein between the rear upper run section and the front upper run section the upper run is supported by
either a deflecting drum,
or a belt support plate.

5. The portioning belt unit according to claim 1, wherein
the drive shaft has an input end and an output end,
wherein
the drive shaft extends in transverse direction over the entire width of the conveyor belt and the output end and the input end are arranged on opposite sides of the conveyor belt with respect to the longitudinal center plane,
the output end is arranged in particular on the operator side of the portioning belt unit.

6. The portioning belt unit according to claim 5, wherein
the drive shaft is arranged, as seen in its axial direction, between the upper run and the lower run of the portioning belt, and the drive shaft is formed as a driven deflecting drum over which the upper run of the portioning belt circulates.

7. The portioning belt unit according to claim 1, wherein
the drive shaft has an input end and an output end; and
wherein
the input end and the output end are arranged on the same side of the longitudinal center plane, and
the output end is arranged in particular on the anti-operator side of the portioning belt unit.

8. The portioning belt unit according to claim 1,
wherein
the output end is operatively connected, in particular via a toothed belt, to at least one of the deflecting drums, in particular the first, front deflecting drum.

9. The portioning belt unit according to claim 1,
wherein
the wrap angle of the driven, middle deflecting drum is a maximum of 35°, in particular a maximum of 30°, in particular a maximum of 20°,
the foremost or rearmost deflecting drum is additionally driven, either by the drive shaft or by the driven, central deflecting drum.

10. The portioning belt unit according to claim 1,
wherein
the portioning belt unit is designed in such a way that the portioning belt unit can be replaced on the machine quickly and in particular without special tools.

11. A slicing machine, in particular slicer, for slicing calibers into slices and producing shingled or stacked portions from slices, having
a cutting unit,
a feed unit for feeding at least one caliber to the cutting unit,
a discharge conveyor having at least one portioning belt unit,
a drive socket, which can be driven in a controlled manner, for coupling with the drive shaft of the portioning belt unit,
a control for controlling moving parts of the slicing machine,
wherein
the portioning belt unit is embodied according to claim 1.

12. The slicing machine according to claim 11,
wherein
viewed in the first transverse direction, the rear upper run section of the portioning belt is or can be set to be approximately parallel to the cutting plane
with a deviation therefrom of at most +/−10°, preferably at most +/−5°.

13. The slicing machine according to claim 11, wherein
the portioning belt unit and the rest of the slicing machine, in particular the discharge conveyor, are embodied in such a way that the portioning belt unit can be replaced quickly and, in particular, without the need for special tools
in particular it can be pulled out of or pushed into the slicing machine in the transverse direction to the passage direction after releasing a locking device.

14. A method for converting a slicing machine, in particular for slicing very flat product calibers or for reverse shingling, in particular a slicing machine according to claim 11, by
changing the portioning belt unit
wherein
the old portioning belt unit is pulled out in the transverse direction towards the operator side after a locking device has been released, and in the process is pulled off a drive socket of the machine,
the new portioning belt unit is merely pushed in from the operator side in the transverse direction and is thereby operatively connected to the drive socket,
the locking device is locked.

15. The method according to claim 14, wherein
before or after insertion of the portioning belt unit, the pivot unit thereof is pivoted relative to the base body thereof in such a way that during the planned working operation there is no longer any slipping down of a portion or partial portion against the transport direction from the beginning of the upper run,
in particular the rear upper run section of the portioning belt is set approximately parallel to the cutting plane.
